(19) United States
(12) Patent Application Publication
(10) Pub. No.: US 2026/0010032 A1
(43) Pub. Date: Jan. 8, 2026

(54) REFLECTIVE DISPLAY DEVICE

(71) Applicant: Iris Optronics Co., Ltd., Tainan City (TW)

(72) Inventors: Chun Kang KU, Hsinchu County (TW); Chi Chang LIAO, Tainan City (TW); Cheng Hong YAO, Tainan City (TW); Chung Hao CHEN, Kaohsiung City (TW)

(21) Appl. No.: 19/260,644

(22) Filed: Jul. 7, 2025

Related U.S. Application Data
(60) Provisional application No. 63/668,321, filed on Jul. 8, 2024.

(30) Foreign Application Priority Data
Apr. 29, 2025 (TW) 114116038

(51) Int. Cl. G02F 1/1335; G02F 1/13363; G02F 1/135; G02F 1/137

(52) U.S. Cl. CPC G02F 1/133536; G02F 1/133638; G02F 1/1351; G02F 1/13718

(57) ABSTRACT

A reflective display device reflects external light including first color light and second color light. The first color light has a first polarization state, and the second color light has a second polarization state. The first color light and the second color light have the same color. The reflective display device includes a first display assembly. The first display assembly includes two first cholesteric liquid crystal modules and a first optical layer. The first cholesteric liquid crystal modules can reflect the first color light. The first optical layer, disposed between the first cholesteric liquid crystal modules, converts the second color light, which passes through one of the first cholesteric liquid crystal module, to the first color light having the first polarization state. The other first cholesteric liquid crystal module reflects the first color light from the first optical layer.

### CROSS-REFERENCE TO RELATED APPLICATION

This application claims priority to U.S. Provisional Application Ser. No. 63/668,321 filed Jul. 8, 2024, and Taiwan Application Serial Number 114,116,038, filed Apr. 29, 2025, the disclosures of which are incorporated herein by reference in their entireties.

### BACKGROUND

### Technical Field

The present disclosure relates to a display device. More particularly, the present disclosure relates to a reflective display device.

### Description of Related Art

A conventional reflective display device, such as a Cholesteric Liquid Crystal Display (ChLCD) device, generally exhibits low reflectance. Consequently, images displayed on such devices suffer from low brightness. For example, the reflectance of most conventional ChLCD device is not greater than 40%, resulting in insufficient image brightness and reduced image quality.

### SUMMARY

The disclosure, according to at least one embodiment, provides a reflective display device that can improve the brightness of images.

A reflective display device according to at least one embodiment is capable of reflecting external light which includes first color light and second color light. The first color light has a first polarization state, and the second color light has a second polarization state. The color of the second color light is the same as that of the first color light. The reflective display device includes a first display assembly, comprising two first cholesteric liquid crystal modules and a first optical layer. These first cholesteric liquid crystal modules reflect the first color light. The first optical layer disposed between these first cholesteric liquid crystal modules converts the second color light (passing through one of the first cholesteric liquid crystal modules) to the first color light with the first polarization state, enabling the other first cholesteric liquid crystal module to reflect the first color light from the first optical layer.

A reflective display device according to another embodiment is capable of reflecting external light which includes first color light, second color light, third color light, fourth color light, fifth color light, and sixth color light. The first color light has a first polarization state. The second color light has a second polarization state. The first color light and the second color light are blue light apiece. The third color light has a third polarization state. The fourth color light has a fourth polarization state. The third color light and the fourth color light are green light apiece. The fifth color light has a fifth polarization state. The sixth color light has a sixth polarization state. The fifth color light and the sixth color light are red light apiece. The reflective display device includes a first display assembly, a second display assembly, and a third display assembly. The first display assembly includes two first cholesteric liquid crystal modules and a first optical layer. These first cholesteric liquid crystal modules are capable of reflecting the first color light. The third color light and the fourth color light pass through the first display assembly. The first optical layer disposed between the two first cholesteric liquid crystal modules is capable of converting the second color light passing through one of the two first cholesteric liquid crystal modules to the first color light having the first polarization state, so that the other one of the two first cholesteric liquid crystal modules reflects the first color light from the first optical layer. The second display assembly disposed under the first display assembly includes two second cholesteric liquid crystal modules and a second optical layer. These second cholesteric liquid crystal modules are capable of reflecting the third color light. The third color light and the fourth color light both from the first display assembly enter the second display assembly. The fifth color light and the sixth color light pass through the first display assembly and the second display assembly. The second optical layer disposed between the two second cholesteric liquid crystal modules is capable of converting the fourth color light passing through one of the two second cholesteric liquid crystal modules to the third color light having the third polarization state, so that the other one of the two second cholesteric liquid crystal modules reflects the third color light from the second optical layer. The third display assembly is disposed under the second display assembly. The second display assembly is located between the first display assembly and the third display assembly. The fifth color light and the sixth color light from the second display assembly enter the third display assembly. The third display assembly includes two third cholesteric liquid crystal modules and a third optical layer. These third cholesteric liquid crystal modules are capable of reflecting the fifth color light. The third optical layer disposed between the two third cholesteric liquid crystal modules converts the sixth color light passing through one of the two third cholesteric liquid crystal modules to the fifth color light having the fifth polarization state, so that the other one of the two third cholesteric liquid crystal modules reflects the fifth color light from the third optical layer.

Based on the above, the previous optical layer (such as the first optical layer) converts the polarization state of color light (e.g., converts the polarization state of second color light from the second polarization state to the first polarization state), and thus each display assembly (e.g., the first display assembly) of the display device can reflect color light with two different polarization states. As a result, the display assembly can reflect the light having the same colors but different polarization states, thereby increasing the overall reflectance of reflective display device.

It is to be understood that both the foregoing general description and the following detailed description are by way of example and are intended to further explain the disclosure as claimed.

### BRIEF DESCRIPTION OF THE DRAWINGS

The disclosure can be more fully understood by reading the following detailed description of the embodiments, with reference to the accompanying drawings as follows:

FIG. 1 is a cross-sectional view of a reflective display device according to at least one embodiment of this disclosure.

FIG. 2 is a cross-sectional view of a reflective display device according to another embodiment of this disclosure.

FIG. 3 is a cross-sectional view of a reflective display device according to another embodiment of this disclosure.

FIG. 4 is a cross-sectional view of a reflective display device according to another embodiment of this disclosure.

FIG. 5 is a cross-sectional view of a reflective display device according to another embodiment of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or similar parts.

In the following description, in order to clearly present the technical features of the present disclosure, the dimensions (such as length, width, thickness, and depth) of elements (such as layers, films, substrates, and areas) in the drawings are shown in exaggerated proportions, and the quantity of some elements will be reduced. Accordingly, the description and explanation of the following embodiments are not limited to the quantity, sizes, and shapes of the elements presented in the drawings, but should also encompass variations in sizes, shapes, and deviations arising from actual manufacturing processes and/or tolerances. For example, a flat surface shown in the drawings may, in reality, have rough and/or non-linear characteristics, and an acute angle depicted may actually be rounded. Therefore, the elements presented in the drawings are primarily for illustration and are not intended to accurately represent the actual shapes of the elements or to limit the scope of the present patent application.

It should be understood that, although the terms first, second, third, etc. may be used herein to describe various elements, components, regions, layers, portions, and/or sections, these elements, components, regions, layers, portions, and/or sections should not be limited by these terms. These terms are only used to distinguish one element, component, region, layer, portion or section from another element, component, region, layer, or section. Thus, a first element, component, region, layer, portion, or section discussed below could be termed a second element, component, region, layer, portion, or section without departing from the teachings of the present disclosure.

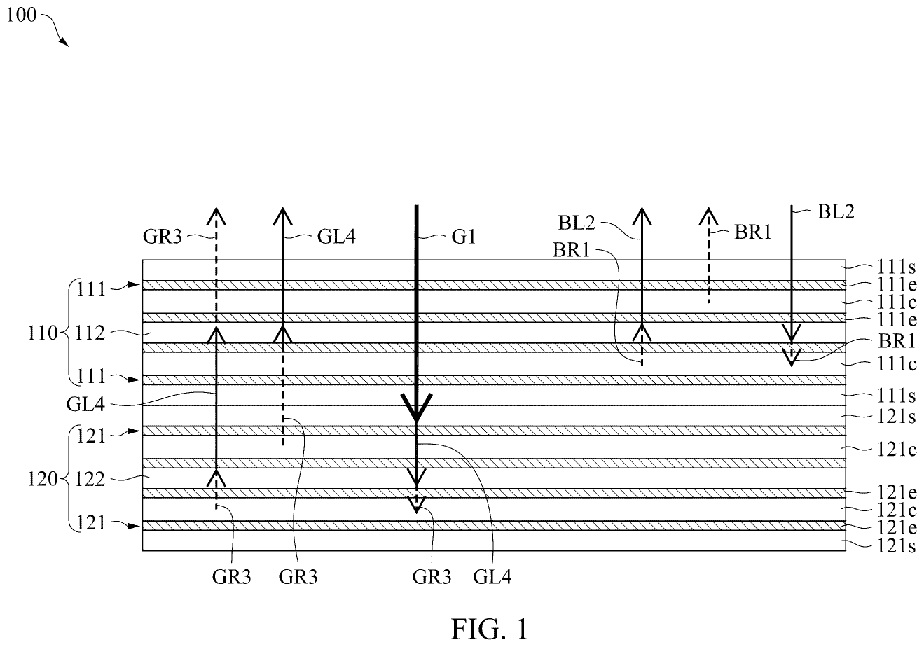

FIG. 1 is a cross-sectional view of a reflective display device according to at least one embodiment of this disclosure. Referring to FIG. 1, the reflective display device 100 can be irradiated by external light and reflect the light. The reflective display device 100 can convert the reflective external light to an image. The external light may be ambient light and include multiple kinds of color light, such as red light, green light, and blue light.

The reflective display device 100 includes multiple display assemblies, the structures of which are similar to each other. Taking FIG. 1 for example, the reflective display device 100 includes a first display assembly 110 and a second display assembly 120. The second display assembly 120 is disposed beneath the first display assembly 110, and the two assemblies are arranged opposite to each other. In other words, the first display assembly 110 and the second display assembly 120 may be in a stacked configuration. In addition, the reflective display device 100 may further include an Optical Clear Adhesive (OCA, not shown), which is disposed between the first display assembly 110 and the second display assembly 120, adhering to both.

The first display assembly 110 includes two first cholesteric liquid crystal modules 111 and a first optical layer 112, where the first optical layer 112 is disposed between the two first cholesteric liquid crystal modules 111. The second display assembly 120 includes two second cholesteric liquid crystal modules 121 and a second optical layer 122, where the second optical layer 122 is disposed between the two second cholesteric liquid crystal modules 121.

The first optical layer 112 can be sandwiched between the two first cholesteric liquid crystal modules 111 by using OCA. Likewise, the second optical layer 122 can also be sandwiched between the two second cholesteric liquid crystal modules 121 by using OCA. In addition, at least one of the first optical layer 112 and the second optical layer 122 may be made of OCA and thus be adhesive, allowing the first optical layer 112 to bond the two first cholesteric liquid crystal modules 111 together, and the second optical layer 122 to bond the two second cholesteric liquid crystal modules 121 together.

Each of the first cholesteric liquid crystal modules 111 includes a first cholesteric liquid crystal layer 111c and two first electrodes 111e, with the first cholesteric liquid crystal layer 111c disposed between the two first electrodes 111e. Similarly, each of the second cholesteric liquid crystal modules 121 includes a second cholesteric liquid crystal layer 121c and two second electrodes 121e, with the second cholesteric liquid crystal layer 121c disposed between the two second electrodes 121e.

In the first display assembly 110, the composition of the first cholesteric liquid crystal layers 111c is the same. Likewise, in the second display assembly 120, the composition of the second cholesteric liquid crystal layers 121c is the same. In other words, all cholesteric liquid crystal layers with a single display assembly have the same composition. However, the composition of the cholesteric liquid crystal layers differs between different display assemblies. That is, the composition of the first cholesteric liquid crystal layer 111c is different from that of the second cholesteric liquid crystal layer 121c.

The first electrodes 111e may be the same as the second electrodes 121e, and both the first electrodes 111e and the second electrodes 121e may be transparent conductive layers. These layers can be made of transparent conductive oxide (TCO), such as indium tin oxide (ITO) or indium zinc oxide (IZO). Alternatively, the first electrodes 111e and the second electrodes 121e can also be made of nanomaterials, such as silver nanowires.

The first electrodes 111e and the second electrodes 121e each form a conductive pattern. In the first cholesteric liquid crystal module 111, portions of the first electrodes 111e overlap to form multiple overlapping areas, which correspond to multiple subpixels of the first display assembly 110. Similarly, in the second cholesteric liquid crystal module 121, portions of the second electrodes 121e overlap to form overlapping areas, which correspond to multiple subpixels of the second display assembly 120.

Each cholesteric liquid crystal module, such as the first cholesteric liquid crystal module 111 or the second cholesteric liquid crystal module 121, may include at least one transparent substrate. For example, as shown in FIG. 1, each first cholesteric liquid crystal module 111 includes a first transparent substrate 111s, and each second cholesteric liquid crystal module 121 includes a second transparent substrate 121s. These substrates may be made of glass substrates, sapphire substrates, or plastic substrates.

In the first cholesteric liquid crystal module 111, the first electrodes 111e may be disposed on the first transparent substrate 111s and the first optical layer 112, respectively. Likewise, in the second cholesteric liquid crystal module 121, the second electrodes 121e may be disposed on the second transparent substrate 121s and the second optical layer 122, respectively. Thus, the first transparent substrate 111s and the second transparent substrate 121s support the first electrodes 111e and the second electrodes 121e.

The first optical layer 112 and the second optical layer 122 can be identical waveplates (also called phase retarders). For example, both are half-wave plates, so each can convert left-handed polarized light to right-handed polarized light, and vice versa. Additionally, these optical layers may serve as rigid substrates, supporting the first electrodes 111e on both sides of the first optical layer 112 and the second electrodes 121e on both sides of the second optical layer 122.

It should be noted that in another embodiment (not shown), each first cholesteric liquid crystal module 111 may include two first transparent substrates 111s, and each second cholesteric liquid crystal module 121 may include two second transparent substrates 121s. The first electrodes 111e are disposed on their respective first transparent substrates 111s, and the second electrodes 121e are disposed on their respective second transparent substrates 121s.

Accordingly, in the first cholesteric liquid crystal module 111, the first electrodes 111e and the first cholesteric liquid crystal layer 111c can be located between two first transparent substrates 111s. In the second cholesteric liquid crystal module 121, the second electrodes 121e and the second cholesteric liquid crystal layer 121c can be located between two second transparent substrates 121s. In addition, the first optical layer 112 can be sandwiched between two adjacent first transparent substrates 111s, while the second optical layer 122 can be sandwiched between two adjacent second transparent substrates 121s.

The external light may be environmental light, such as sunlight or the light from an indoor source, so the external light includes many kinds of color light (such as red, green, and blue light). The external light includes first color light BR1, second color light BL2, third color light GR3, and fourth color light GL4, where the color of the first color light BR1 is the same as that of the second color light BL2, while the color of the third color light GR3 is the same as that of the fourth color light GL4. However, the colors of both first color light BR1 and the second color light BL2 are different from those of the third color light GR3 and the fourth color light GL4.

The first color light BR1 has a first polarization state, and the second color light BL2 has a second polarization state, distinct from the first polarization state. The third color light GR3 has a third polarization state, and the fourth color light GL4 has a fourth polarization state, distinct from the third polarization state. Hence, the first color light BR1 and the second color light BL2 have different polarization states. Similarly, the third color light GR3 and the fourth color light GL4 have different polarization states.

The first through the fourth polarization state are all rotary polarization states, where rotary polarization states are divided into left-handed polarization state and right-handed polarization state. In this embodiment, the first polarization state and the third polarization state are both first rotary polarization state, while the second polarization state and the fourth polarization state are both second rotary polarization state. The first rotary polarization state is different from the second rotary polarization state. In other words, the first polarization state and the third polarization state are the same polarization states, while the second polarization state and the fourth polarization state are the same polarization states, but each of the first polarization state and the third polarization state is different from either the second polarization state or the fourth polarization state.

Generally speaking, the cholesteric liquid crystal layer reflects the light both within a specific wavelength range (i.e., the light with a specific color) and with a specific polarization state. For example, the cholesteric liquid crystal layer usually reflects either left-handed polarized light or right-handed polarized light, so that the first cholesteric liquid crystal layer 111c and the second cholesteric liquid crystal layer 121c each reflect the light with a single rotary polarization state.

Taking FIG. 1 as an example, the first rotary polarization states of both the first color light BR1 and the third color light GR3 are right-handed polarization states, while the second rotary polarization states of both the second color light BL2 and the fourth color light GL4 are left-handed polarization states. Consequently, the first cholesteric liquid crystal layer 111c and the second cholesteric liquid crystal layer 121c reflect right-handed polarized light, so that the first cholesteric liquid crystal modules 111 and the second cholesteric liquid crystal modules 121 reflect the first color light BR1 and the third color light GR3 that have the right-handed polarization state, respectively, and allow the second color light BL2 and the fourth color light GL4 that have the left-handed polarization state to pass through.

The wavelength ranges of both the third color light GR3 and the fourth color light GL4 are different from those of both the first color light BR1 and the second color light BL2. For example, the first color light BR1 and the second color light BL2 could both be blue light, while the third color light GR3 and the fourth color light GL4 could both be green light. Consequently, the first cholesteric liquid crystal layer 111c allows the third color light GR3 and the fourth color light GR4 to transmit, i.e., the third color light GR3 and the fourth color light GL4 pass through the first display assembly 110.

When the external light irradiates the reflective display device 100, the first cholesteric liquid crystal modules 111 reflect the first color light BR1, and the second cholesteric liquid crystal modules 121 reflect the third color light GR3. Accordingly, the reflective display device 100 can display images.

As external light enters one of the first display assemblies 110, for example, the first display assembly 110 in FIG. 1—the first color light BR1 in the external light is reflected by the upper first cholesteric liquid crystal module 111, while the second color light BL2, the third color light GR3, and the fourth color light GL4 in the external light pass through it. The colors of both the third color light GR3 and the fourth color light GL4 are the same (i.e., they share the same wavelength), so the third color light GR3 and the fourth color light GLA combine to form a monochromatic light G1, such as green light, within the external light. Thus, the monochromatic light G1 in FIG. 1 comprises both the third color light GR3 and the fourth color light GL4.

The second color light BL2, the third color light GR3, and the fourth color light GL4 all pass through the upper first cholesteric liquid crystal module 111 and enter the first optical layer 112, positioned between the two first cholesteric liquid crystal modules 111. The first optical layer 112, which may be a half-wave plate, converts left-handed polarization state to right-handed polarization state, and converts right-handed polarization state to left-handed polarization state, where the first polarization state and the second polarization state are circularly polarized, but have different polarization states (i.e., circularly left-handed polarization state and circularly right-handed polarization state). Hence, the first optical layer 112 converts the second color light BL2, having the second polarization state and passing through one of the first cholesteric liquid crystal modules 111 (e.g., the upper first cholesteric liquid crystal module 111 in FIG. 1), to the first color light BR1 having the first polarization state.

Subsequently, the first color light BR1, converted by the first optical layer 112, enters the other first cholesteric liquid crystal modules 111 (e.g., the lower first cholesteric liquid crystal module 111 in FIG. 1), and the previous first cholesteric liquid crystal module 111 (e.g., the lower first cholesteric liquid crystal module 111 in FIG. 1) reflects the converted first color light BR1 back toward the first optical layer 112. The first optical layer 112 then reconvert the reflected first color light BR1 to the second color light BL2, which passes through the upper first cholesteric liquid crystal module 111 and then exits the first display assembly 110.

As a result, the first optical layer 112 converts the second color light BL2 in the external light to the first color light BR1, while each of the first cholesteric liquid crystal modules 111 in the first display assembly 110 reflects the first color light BR1. Consequently, the first display assembly 110 reflects both the first color light BR1 and the second color light BL2 in the external light, thereby increasing the overall reflectance of the first display assembly 110.

The third color light GR3 and the fourth color light GL4 in the external light pass through the first cholesteric liquid crystal modules 111, i.e., pass through the first display assembly 110. Hence, the third color light GR3 and the fourth color light GLA—combining to form the monochromatic light G1 shown in FIG. 1—then enter the second display assembly 120, pass through the second transparent substrate 121s, and enter one of the second cholesteric liquid crystal modules 121 (e.g., the upper second cholesteric liquid crystal module 121 in FIG. 1).

Similarly to the first display assembly 110, the third color light GR3 in the monochromatic light G1 is reflected by the upper second cholesteric liquid crystal module 121, but the fourth color light GL4 in the monochromatic light G1 passes through the second cholesteric liquid crystal module 121 and enters the second optical layer 122. The second optical layer 122 converts the fourth color light GL4 which has the fourth polarization state and has passed through one of the second cholesteric liquid crystal modules 121 (e.g., the upper second cholesteric liquid crystal module 121 in FIG. 1)—to the third color light GR3 with the third polarization state. The third polarization state is a first rotary polarization state (e.g., right-handed polarization state), and the fourth polarization state is a second rotary polarization state (e.g., left-handed polarization state).

Afterwards, the third color light GR3, converted by the second optical layer 122, enters the other second cholesteric liquid crystal module 121 (e.g., the lower second cholesteric liquid crystal module 121 in FIG. 1), and the lower second cholesteric liquid crystal module 121 reflects the converted third color light GR3 from the second optical layer 122. This causes the lower second cholesteric liquid crystal module 121 to reflect the third color light GR3 back to the second optical layer 122. The second optical layer 122 then reconvert the reflected light GR3 to the fourth color light GL4. Consequently, the fourth color light GL4 (converted by the second optical layer 122) passes through the upper second cholesteric liquid crystal module 121, and enters the first display assembly 110.

The first optical layer 112 and the second optical layer 122 can convert the first rotary polarization state (right-handed polarization state) to the second rotary polarization state (left-handed polarization state), and vice versa. When the third color light GR3 reflected by the upper second cholesteric liquid crystal module 121 without passing through the second optical layer 122, it returns to the first display assembly 110 and is converted to the fourth color light GL4 by the first optical layer 112. Meanwhile, the fourth color light GL4—after being converted by the second optical layer 122 and reflected by the lower second cholesteric liquid crystal module 121—reenters the first display assembly 110, where the first optical layer 112 converts it back to the third color light GR3.

As a result, the second optical layer 122 converts the fourth color light GL in external light to the third color light GR3. Each second cholesteric liquid crystal module 121 in the second display assembly 120 reflects the third color light GR3, enabling the second display assembly 120 reflects both the third color light GR3 and the fourth color light GL4 of external light. This increases the overall reflectance of the second display assembly 120. Accordingly, by incorporating the first optical layer 112 and the second optical layer 122, the overall reflectance of the reflective display device 100 increases significantly, and potentially doubling the reflectance (in the absence of any optical layer, for example, the first optical layer 112 and the second optical layer 122). This enables the reflectance of the reflective display device 100 exceeding 40%, improving the brightness of images and the quality of image.

Notably, when the monochromatic light G1 passes through the first display assembly 110, the first optical layer 112 converts both the third color light GR3 and the fourth color light GL4 within G1. However, the output light from the first display assembly 110 still contains both the third color light GR3 and the fourth color light GL4. Crucially, these polarization conversions occur in a complementary manner so that the net polarization state of the G1 light remains substantially unchanged. Therefore, the first display assembly 110 does not alter the polarization state of monochromatic light G1.

In the embodiment shown in FIG. 1, the reflective display device 100 includes at least two display assemblies: the first display assembly 110 and the second display assembly 120. However, in another embodiment, the reflective display device 100 may include only one display assembly. For example, the second display assembly 120 could be omitted entirely. Thus, the quantity of the display assemblies in the reflective display device 100 is not limited to any specific configuration.

Furthermore, in the embodiment shown in FIG. 1, the first rotary polarization state is right-handed polarization state, while the second rotary polarization state is left-handed polarization state. That is, both the first color light BR1 and the third color light GR3 are right-handed polarized light, while both the second color light BL2 and the fourth color light GL4 are left-handed polarized light. However, in another embodiment, the first rotary polarization state may be left-handed polarization state, and the second rotary polarization state may be right-handed polarization state. Thus, both the first color light BR1 and the third color light GR3 may be left-handed polarized light, while both the second color light BL2 and the fourth color light GL4 may be right-handed polarized light.

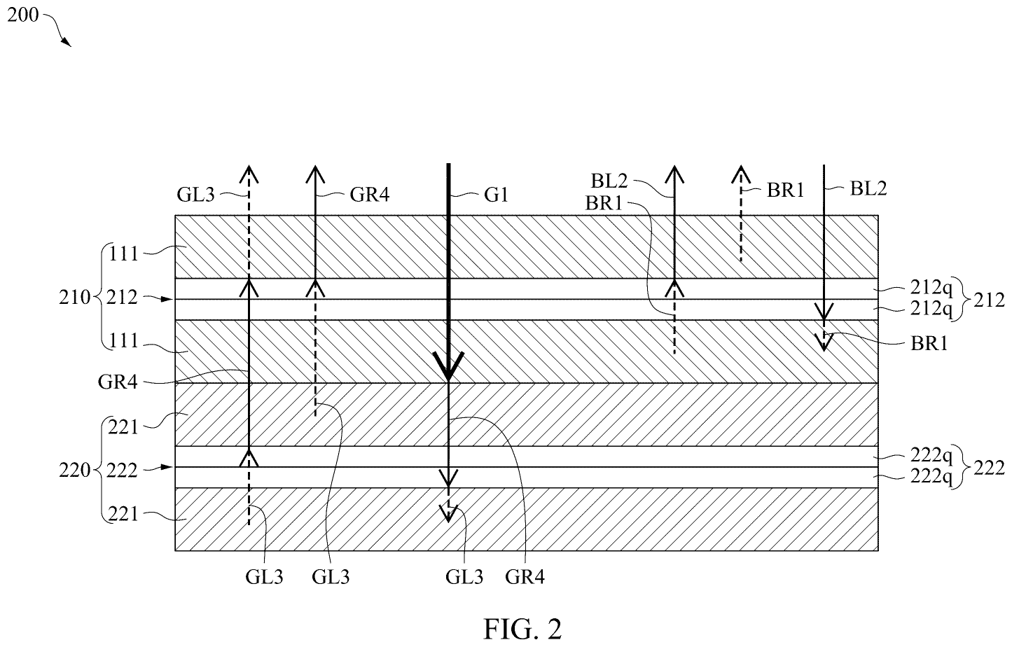

FIG. 2 is a cross-sectional view of a reflective display device according to another embodiment of this disclosure. As shown in FIG. 2, the reflective display device 200 shares structural and functional similarities with the reflective display device 100 of the previous embodiment. Both devices achieve equivalent optical effects and incorporate common elements such as the first cholesteric liquid crystal modules 111 and the second cholesteric liquid crystal modules 221. The following description focus exclusively on the differences between the reflective display devices 100 and 200, identical features will not be reiterated.

The reflective display device 200 includes a first display assembly 210 and a second display assembly 220. The first display assembly 210 comprises two first cholesteric liquid crystal modules 111, with a first optical layer 212 disposed between them. Similarly, the second display assembly 220 comprises two second cholesteric liquid crystal modules 221, with a second optical layer 222 disposed between them.

Unlike the reflective display device 100, the first optical layer 212 comprises two stacked quarter-wave plates 212q with aligned slow axes, functioning as a half-wave retarder. Similarly, the second optical layer 222, which may be identical to the first optical layer 212, also consists of two stacked quarter-wave plates 222q with aligned slow axes, thereby acting as a half-wave retarder.

Since the first optical layer 212 and the second optical layer 222 function as half-wave retarders, they are optically equivalent to half-wave plates. Consequently, their optical functions are identical to those of the previous first optical layer 112 and the second optical layer 122. Therefore, similar to the first display assembly 110, the first display assembly 210 also reflects both the first color light BR1 and the second color light BL2 in external light, thereby increasing its overall reflectance.

The structures of the first cholesteric liquid crystal modules 111 and the second cholesteric liquid crystal modules 221 in FIG. 2 are substantially the same as those of the first cholesteric liquid crystal modules 111 and the second cholesteric liquid crystal modules 121 in FIG. 1. Accordingly, like the second cholesteric liquid crystal module 121 in FIG. 1, each of the second cholesteric liquid crystal modules 221 in FIG. 2 also includes two second electrodes 121e, with a second cholesteric liquid crystal layer disposed between them.

Accordingly, the cross-sectional structure of the second cholesteric liquid crystal module 221 in FIG. 2 is substantially identical to that of the second cholesteric liquid crystal module 121 in FIG. 1. Therefore, FIG. 2 depicts blocks for representing both the first cholesteric liquid crystal modules 111 and the second cholesteric liquid crystal modules 221, omitting internal structures such as the first electrodes 111e and the second electrodes 121e. The second cholesteric liquid crystal layers of the second cholesteric liquid crystal modules 221 reflect the third color light GL3 (with third polarization state) while transmitting the fourth color light GR4 (with fourth polarization state).

Unlike the second cholesteric liquid crystal modules 121 in FIG. 1, the first polarization state of the first color light BR1 and the fourth polarization state of the fourth color light GR4 are first rotary polarization states, while the second polarization state of the second color light BL2 and the third polarization state of the third color light GL3 are second rotary polarization states. The first rotary polarization state is right-handed polarization state and the second rotary polarization state is left-handed polarization state. Accordingly, unlike the embodiment in FIG. 1, for the embodiment shown in FIG. 2, the third color light GL3 is left-handed polarized light and the fourth color light GR4 is right-handed polarized light. Thus, the second cholesteric liquid crystal modules 221 reflect the third color light GL3 having left-handed polarization state while transmitting the fourth color light GR4 having right-handed polarization state.

The third color light GL3 and the fourth color light GR4 share identical color characteristics (e.g., both green). Specifically, the third color light GL3 in FIG. 2 is corresponding to the fourth color light GL4 in FIG. 1, and the fourth color light GR4 in FIG. 2 is corresponding to the third color light GR3 in FIG. 1. Thus, the third color light GL3 and the fourth color light GR4 combine to form the monochromatic light G1 (e.g., green light). In other words, the monochromatic light G1 comprises both the third color light GL3 and the fourth color light GR4.

Since the third color light GL3 (in FIG. 2) corresponds to the fourth color light GL4 (in FIG. 1) and the fourth color light GR4 (in FIG. 2) corresponds to the third color light GR3 (in FIG. 1), the second optical layer 222 converts the fourth color light GR4 to the third color light GL3. This enables each second cholesteric liquid crystal module 221 in the second display assembly 220 reflects both the third color light GL3 and the fourth color light GR4, thereby increasing the overall reflectance of the second display assembly 220.

Notably, since both the first optical layer 212 and the second optical layer 222 in FIG. 2 function as half-wave plates, they can be replaced by their counterparts in FIG. 1. Furthermore, any optical layer in FIG. 2 (e.g., two quarter-wave plates) can be substituted with an optical layer in FIG. 1 (e.g., half-wave plate). For example, replace the first optical layer 212 in FIG. 2 with the first optical layer 112 in FIG. 1, while retaining the second optical layer 222 in FIG. 2. In another embodiment, replace the second optical layer 222 in FIG. 2 with the second optical layer 122 in FIG. 1, while retaining the first optical layer 212 in FIG. 2.

Moreover, in this embodiment, the first rotary polarization state is right-handed polarization state, and the second rotary polarization state is left-handed polarization state. That is, the first color light BR1 and the fourth color light GR4 are both right-handed polarized light, while the second color light BL2 and the third color light GL3 are both left-handed polarized light. However, in another embodiment, using different cholesteric liquid crystal layers, the first rotary polarization state can be left-handed polarization state, while the second rotary polarization state can be right-handed polarization state. That is, the first color light BR1 and the fourth color light GR4 can be left-handed polarized light, while the second color light BL2 and the third color light GL3 can be right-handed polarized light.

In addition, the third color light GL3 (in FIG. 2) is identical to the fourth color light GL4 (in FIG. 1), and the fourth color light GR4 (in FIG. 2) is identical to the third color light GR3 (in FIG. 1). Consequently, the reflective display device 200 in this embodiment reflects both the third color light GL3 (i.e., the fourth color light GL4 in FIG. 1) and the fourth color light GR4 (i.e., the third color light GR3 in FIG. 1). This interchangeability holds even when replacing the second cholesteric liquid crystal module 221 in FIG. 2 with the second cholesteric liquid crystal module 121 in FIG. 1. Therefore, the second cholesteric liquid crystal module 221 in FIG. 2 can be substituted with the second cholesteric liquid crystal module 121 in FIG. 1.

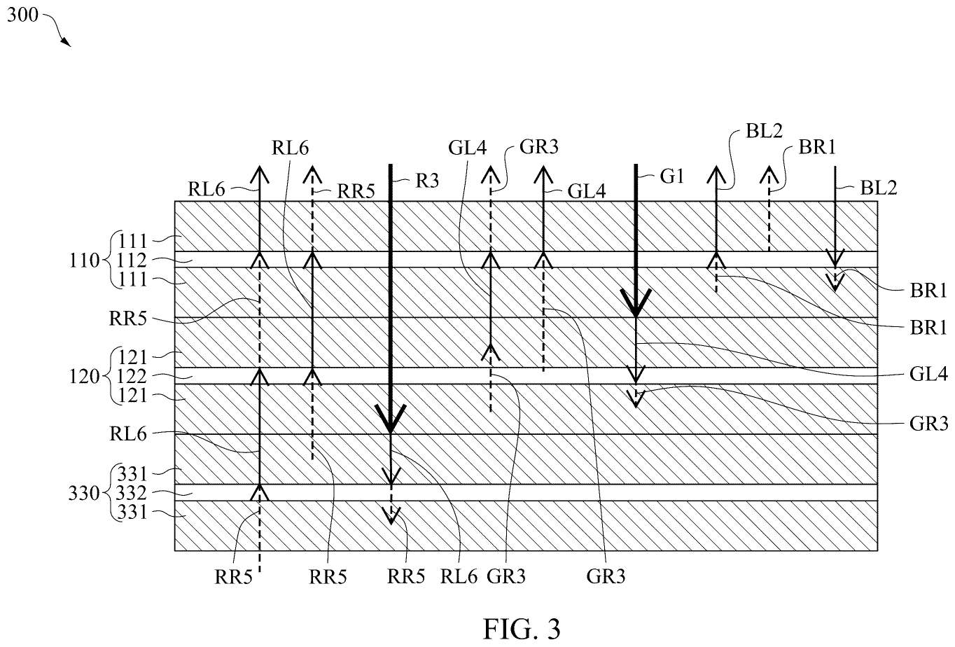

FIG. 3 is a cross-sectional view of a reflective display device according to another embodiment of this disclosure. Referring to FIG. 3, the reflective display device 300 of this embodiment shares structural and functional similarities with the reflective display device 100 described previously. Both devices exhibits identical optical effects and incorporated the same or similar core elements, such as the first display assembly 110 and the second display assembly 120. The following description focuses on the differences between the reflective display devices 100 and 300; shared features are not redundantly addressed.

Unlike the previous reflective display device 100, the reflective display device 300 incorporates three display assemblies: the first display assembly 110, the second display assembly 120, and a third display assembly 330. The third display assembly 330 is positioned beneath the second display assembly 120, with the second display assembly 120 located between the first display assembly 110 and the third display assembly 330. All three display assemblies share similar structural configurations. For example, the third display assembly 330 comprises two third cholesteric liquid crystal modules 331 and a third optical layer 332 interposed between them. This third optical layer 332 may be identical to the first optical layer 112, specifically a half-wave plate.

The structures of all of the first cholesteric liquid crystal module 111, the second cholesteric liquid crystal module 121, and the third cholesteric liquid crystal module 331 are substantially the same. Each third cholesteric liquid crystal module 331 also contains two third electrodes with a third cholesteric liquid crystal layer between them, mirroring the cross-sectional structure of the first cholesteric liquid crystal module 111 and the second cholesteric liquid crystal module 121 shown in FIG. 1. Consequently, FIG. 3 represents all three modules (the first cholesteric liquid crystal modules 111, the second cholesteric liquid crystal modules 121, and the third cholesteric liquid crystal modules 331) as simplified blocks, omitting internal structures like electrodes (e.g., the first electrodes 111e) and liquid crystal layers (e.g., the second cholesteric liquid crystal layers 121c)—consistent with the schematic approach in FIG. 2.

The external light includes not only the first color light BR1, the second color light BL2, the third color light GR3, and the fourth color light GL4, but also a fifth color light RR5 and a sixth color light RL6. The fifth color light RR5 and the sixth color light RL6 are the same color as each other, but their color are completely different from that of the first color light BR1 and the second color light BL2 as well as from the third color light GR3 and the fourth color light GL4.

Specifically, the wavelength ranges of both the fifth color light RR5 and the sixth color light RL6 differ from those of the first color light BR1/the second color light BL2 and the third color light GR3/the fourth color light GL4. For example, in this embodiment, the first color light BR1 and the second color light BL2 are blue light, the third color light GR3 and the fourth color light GL4 are green light, and the fifth color light RR5 and the sixth color light RL6 are red light.

The fifth color light RR5 has a fifth polarization state, while the sixth color light RL6 has a sixth polarization state, where the fifth polarization state is different from the sixth polarization state. The fifth polarization state and the sixth polarization state are all rotary polarization states, which are divided into left-handed polarization state and right-handed polarization state. In the embodiment shown in FIG. 3, the first polarization state of the first color light BR1, the third polarization state of the third color light GR3, and the fifth polarization state of the fifth color light RR5 are first rotary polarization states, while the second polarization state of the second color light BL2, the fourth polarization state of the fourth color light GL4, and the sixth polarization state of the sixth color light RL6 are second rotary polarization states.

The first rotary polarization state may be right-handed polarization state, and the second rotary polarization state may be left-handed polarization state. That is to say, the first color light BR1, third color light GR3, and the fifth color light RR5 may each be the right-handed polarized light, while the second color light BL2, the fourth color light GL4, and the sixth color light RL6 may each be the left-handed polarized light. In another embodiment, using different cholesteric liquid crystal layer, the first rotary polarization state can be left-handed polarization state, while the second rotary polarization state can be right-handed polarization state. Thus, the first color light BR1, third color light GR3, and the fifth color light RR5 can be the left-handed polarized light, while the second color light BL2, the fourth color light GL4, and the sixth color light RL6 can be the right-handed polarized light.

The fifth color light RR5 and the sixth color light RL6 combine to form monochromatic light R3 (e.g., red light). Thus, the monochromatic light R3 comprises the fifth color light RR5 and the sixth color light RL6. The monochromatic light R3 passes through the first display assembly 110 and the second display assembly 120, causing both the fifth color light RR5 and the sixth color light RL6 from the second display assembly 120 to enter the third display assembly 330.

Notably, as monochromatic light R3 passes through the first display assembly 110 and the second display assembly 120, the first optical layer 112 and the second optical layer 122 alter the polarization state of the fifth color light RR5 and the sixth color light RL6 within monochromatic light R3. However, the monochromatic light R3 emerging from these assemblies still contains both the fifth color light RR5 and the sixth color light RL6. Thus, the first display assembly 110 and the second display assembly 120 do not substantially affect the polarization state of the monochromatic light R3.

The third cholesteric liquid crystal module 331 reflect the fifth color light RR5 having the right-handed polarization state and transmit the sixth color light RL6 having the left-handed polarization state. After monochromatic light R3 enters the third display assembly 330, one of the third cholesteric liquid crystal modules 331 (e.g., the upper third cholesteric liquid crystal module 331 in FIG. 3) reflects the fifth color light RR5, preventing it from entering the third optical layer 332.

The fifth color light RR5 bypasses the third optical layer 332 and enters the second display assembly 120, where it is converted to the sixth color light RL6 by the second optical layer 122. Subsequently, the sixth color light RL6 exits the second display assembly 120 and enters the first display assembly 110, where it is converted to the fifth color light RR5 by the first optical layer 112. Finally, the reconverted fifth color light RR5 emits from the first display assembly 110.

The sixth color light RL6, after passing through the third cholesteric liquid crystal modules 331, enters the third optical layer 332. The third optical layer 332 then converts the sixth color light RL6 to the fifth color light RR5 with a right-handed polarization state. The converted fifth color light RR5 enters the other third cholesteric liquid crystal modules 331 (e.g., the lower third cholesteric liquid crystal module 331 in FIG. 3), which reflects the fifth color light RR5 back toward the third optical layer 332. As a result, the third optical layer 332 converts the reflected fifth color light RR5 back to the sixth color light RL6.

The sixth color light RL6, converted by the third optical layer 332, passes through the upper third cholesteric liquid crystal module 331 in FIG. 3 and then enters the second display assembly 120. Within the second display assembly 120, the second optical layer 122 converts the sixth color light RL6 to the fifth color light RR5. Subsequently, when the fifth color light RR5 enters the first display assembly 110, the first optical layer 112 converts the fifth color light RR5 back to the sixth color light RL6.

As a result, similar to the first display assembly 110 and the second display assembly 120, the third optical layer 332 of the third display assembly 330 enables each of the third cholesteric liquid crystal modules 331 to reflect the fifth color light RR5. Thus, the third display assembly 330 reflect both the fifth color light RR5 and the sixth color light RL6, thereby increasing its overall reflectance.

It is important to note that in the embodiment shown in FIG. 3, both the first color light BR1 and the second color light BL2 are blue light, both the third color light GR3 and the fourth color light GL4 are green light, and both the fifth color light RR5 and the sixth color light RL6 are red light. Thus, the reflective display device 300 displays color images by reflecting red light, green light, and blue light. In addition, the reflective display device 300 can use different cholesteric liquid crystal layers to reflect cyan light, yellow light, and magenta light. Specifically, the first color light BR1 and the second color light BL2 can be cyan light, the third color light GR3 and the fourth color light GL4 can be yellow light, and the fifth color light RR5 and the sixth color light RL6 can be magenta light, enabling alternative reflective display device 300 to display color images.

It is necessary to note that in the embodiment shown in FIG. 3, the first optical layer 112 and the second optical layer 122 can be replaced with the first optical layer 212 and the second optical layer 222 in FIG. 2 respectively. The third optical layer 332 can be replaced by two stacked quarter-wave plates. Thus, the reflective display device 300 can use the quarter-wave plates as the optical layer in a display assembly. Additionally, the reflective display device 300 may include a half-wave plate and the quarter-wave plates. For example, in FIG. 3, the first display assembly 110 may remain unchanged, while the second display assembly 120 can be replaced by the second display assembly 220 in FIG. 2. This configuration results in the reflective display device 300 incorporating the first optical layer 112 and the second optical layer 222.

Moreover, the first cholesteric liquid crystal modules 111, the second cholesteric liquid crystal modules 121, and the third cholesteric liquid crystal modules 331 reflect right-handed polarized light for the first color light BR1, the third color light GR3, and the fifth color light RR5 respectively. However, in other embodiments, each of the cholesteric liquid crystal modules of the reflective display device 300 can also reflect left-handed polarized light. Alternatively, all of the cholesteric liquid crystal modules in the reflective display device 300 may reflect both left-handed polarized light and right-handed polarized light. Thus, each of the cholesteric liquid crystal modules of the reflective display device 300 is not limited to reflecting only right-handed polarized light or left-handed polarized light.

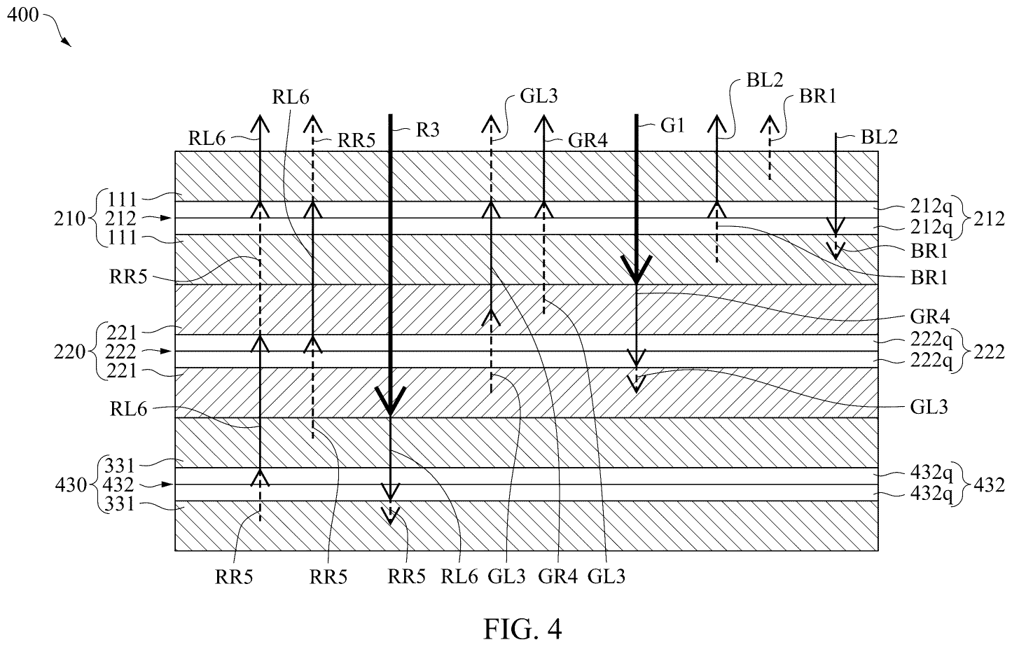

FIG. 4 is a cross-sectional view of a reflective display device according to another embodiment of this disclosure. As shown in FIG. 4, the reflective display device 400 is similar to the reflective display device 300 described in the previous embodiment. The reflective display devices 300 and 400 have the same effects and include the same or similar elements. The following description focuses primarily on the differences between the reflective display devices 300 and 400, features that are the same in both devices are not repeated.

Unlike the previous reflective display device 300, all optical layers in the reflective display device 400 are quarter-wave plates. Specifically, the reflective display device 400 includes the first display assembly 210, the second display assembly 220, and the third display assembly 430. The first optical layer 212, the second optical layer 222, and the third optical layer 432 in the reflective display device 400 each contain multiple quarter-wave plates. For example, the first optical layer 212 contains two stacked quarter-wave plates 212q, the second optical layer 222 contains two stacked quarter-wave plates 222q, and the third optical layer 432 contains two stacked quarter-wave plates 432q. Certainly, the slow axes of all quarter-wave plates are aligned for the optical layer 212, 222 and 432, respectively. Consequently, the first optical layer 212, the second optical layer 222 and the third optical layer 432 can each function as a half-wave plate.

Additionally, the monochromatic light R3 (containing the fifth color light RR5 and the sixth color light RL6) can also pass through both the second cholesteric liquid crystal modules 221 and the first cholesteric liquid crystal modules 111, allowing the fifth color light RR5 and the sixth color light RL6 to exit the reflective display device 400. In the embodiment shown in FIG. 4, the first cholesteric liquid crystal modules 111 and the third cholesteric liquid crystal modules 331 reflect right-handed polarized light (the first color light BR1 and the fifth color light RR5 respectively), and the second cholesteric liquid crystal modules 221 reflects left-handed polarized light (the third color light GL3).

However, in another embodiment, the first cholesteric liquid crystal modules 111 and the third cholesteric liquid crystal modules 331 reflect left-handed polarized light, while the second cholesteric liquid crystal modules 221 reflects right-handed polarized light. Alternatively, the first cholesteric liquid crystal modules 111 and the second cholesteric liquid crystal modules 221 reflect left-handed polarized light, while the second cholesteric liquid crystal modules 221 reflect right-handed polarized light.

In other words, as long as the cholesteric liquid crystal modules within any one of the first display assembly 210, the second display assembly 220, and the third display assembly 430 reflect the color light with the same rotary polarization state, this embodiment does not limit the rotary polarization state (i.e., either left-handed polarization state or right-handed polarization state) of the color light reflected by any one of the first cholesteric liquid crystal module 111, the second cholesteric liquid crystal module 221, or the third cholesteric liquid crystal module 331.

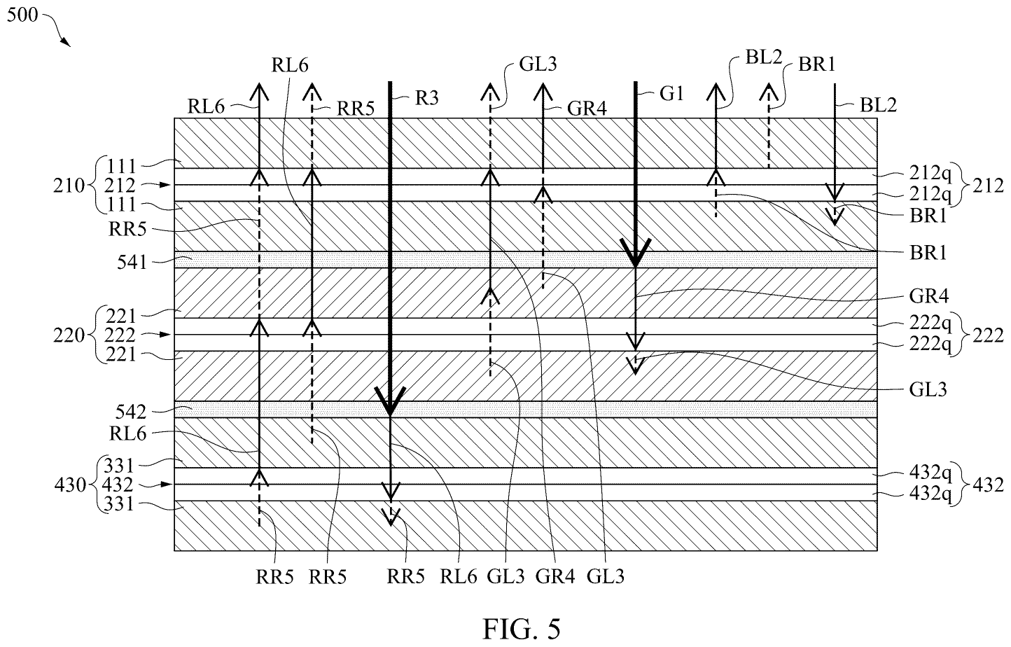

FIG. 5 is a cross-sectional view of a reflective display device according to another embodiment of this disclosure. Referring to FIG. 5, the reflective display device 500 is similar to the reflective display device 400 in FIG. 4. The description below focuses on the differences between them. Specifically, the reflective display device 500 further includes a first light absorption layer 541 and a second light absorption layer 542. Common features of the reflective display devices 500 and 400 are not reiterated.

The first light absorption layer 541 is disposed between the first display assembly 210 and the second display assembly 220. Within the wavelength range of visible light, the first light absorption layer 541 only allows the third color light GL3, the fourth color light GR4, the fifth color light RR5 and the sixth color light RL6 to transmit, and absorbs the light outside the wavelength ranges of these four lights. For example, the first light absorption layer 541 absorbs the light within the wavelength ranges of the first color light BR1 and the second color light BL2.

The second light absorption layer 542 is disposed between the second display assembly 220 and the third display assembly 430. Within the wavelength range of visible light, the second light absorption layer 542 only allows the fifth color light RR5 and the sixth color light RL6 to transmit, while absorbing the light outside these wavelength ranges. For example, the second light absorption layer 542 absorbs the light within the wavelength ranges of the first color light BR1, the second color light BL2, the third color light GL3, and the fourth color light GR4. Additionally, both the first light absorption layer 541 and the second light absorption layer 542 may function as filters.

The cholesteric liquid crystal modules disclosed in the previous embodiments, e.g., the first cholesteric liquid crystal modules 111, the second cholesteric liquid crystal modules 121 and 221, and the third cholesteric liquid crystal modules 331, each reflects the color light at specific wavelengths (e.g., the first color light BR1, the third color light GL3, and the fifth color light RR5) according to Bragg's law. When omnidirectional external light enters the reflective display device 500 at a large incident angle, the wavelengths of the reflected lights (the first color light BR1, the reflected third color light GL3, and the reflected fifth color light RR5) shift to shorter values, reducing color saturation and degrading image quality.

However, the first light absorption layer 541 absorbs the light outside the wavelength ranges of the third color light GL3, the fourth color light GR4, the fifth color light RR5, and the sixth color light RL6—including the first color light BR1 and the second color light BL2. For example, the first light absorption layer 541 absorbs blue light (e.g., first color light BR1), while transmitting both green light (e.g., the third color light GL3) and red light (e.g., the fifth color light RR5).

Likewise, the second light absorption layer 542 absorbs the color light outside the wavelength ranges of both the fifth color light RR5 and the sixth color light RL6—including the first color light BR1 the second color light BL2, the third color light GL3, and the fourth color light GR4. For example, the second light absorption layer 542 absorbs both blue light and green light, while transmitting red light. Thus, using the first light absorption layer 541 and the second light absorption layer 542 eliminates emission of the reflected light that is out of specific wavelength ranges. Thus, the color saturation and image quality of the reflective display device 500 are improved.

The first light absorption layer 541 and the second light absorption layer 542 are also applicable to the previous embodiments. For example, in the reflective display devices 100 and 300 in FIG. 1 and FIG. 3, the first light absorption layer 541 is disposed between the first display assembly 110 and the second display assembly 120. In the reflective display devices 200 and 400 in FIG. 2 and FIG. 4, the first light absorption layer 541 is disposed between the first display assembly 210 and the second display assembly 220. Moreover, in the reflective display device 300 in FIG. 3, the second light absorption layer 542 is disposed between the second display assembly 120 and the third display assembly 330. In the reflective display device 400 in FIG. 4, the second light absorption layer 542 is disposed between the second display assembly 220 and the third display assembly 430.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover such modifications and variations, provided they fall within the scope of the following claims.

What is claimed is:

1. A reflective display device, capable of reflecting an external light, wherein the external light comprises:
a first color light, having a first polarization state;
a second color light, having a second polarization state, wherein a color of the second color light is the same as a color of the first color light, and the reflective display device comprises:
a first display assembly, comprising:
two first cholesteric liquid crystal modules, capable of reflecting the first color light; and
a first optical layer, disposed between the two first cholesteric liquid crystal modules, and capable of converting the second color light passing through one of the two first cholesteric liquid crystal modules to the first color light having the first polarization state, so that the other one of the two first cholesteric liquid crystal modules reflects the first color light from the first optical layer.

2. The reflective display device of claim 1, wherein each of the two first cholesteric liquid crystal modules comprises:
two first electrodes; and
a first cholesteric liquid crystal layer, disposed between the two first electrodes.

3. The reflective display device of claim 1, wherein the first optical layer is a half-wave plate.

4. The reflective display device of claim 1, wherein the first optical layer comprises two quarter-wave plates in a stack.

5. The reflective display device of claim 1, wherein the external light further comprises:
a third color light, having a third polarization state;
a fourth color light, having a fourth polarization state, wherein a color of the third color light is the same as a color of the fourth color light, while the third color light and the fourth color light pass through the first display assembly, wherein the reflective display device further comprises:
a second display assembly, disposed under the first display assembly, wherein the third color light and the fourth color light both from the first display assembly enter the second display assembly, and the second display assembly comprises:
two second cholesteric liquid crystal modules, capable of reflecting the third color light; and
a second optical layer, disposed between the two second cholesteric liquid crystal modules, and capable of converting the fourth color light passing through one of the two second cholesteric liquid crystal modules to the third color light having the third polarization state, so that the other one of the two second cholesteric liquid crystal modules reflects the third color light from the second optical layer.

6. The reflective display device of claim 5, wherein each of the two second cholesteric liquid crystal modules comprises:
two second electrodes; and
a second cholesteric liquid crystal layer, disposed between the two second electrodes.

7. The reflective display device of claim 5, wherein the first polarization state and the third polarization state are a first rotary polarization state apiece, while the second polarization state and the fourth polarization state are a second rotary polarization state apiece, wherein the first rotary polarization state is different from the second rotary polarization state.

8. The reflective display device of claim 7, wherein the first rotary polarization state is a left-handed polarization state, while the second rotary polarization state is a right-handed polarization state.

9. The reflective display device of claim 7, wherein the first rotary polarization state is a right-handed polarization state, while the second rotary polarization state is a left-handed polarization state.

10. The reflective display device of claim 5, wherein the first polarization state and the fourth polarization state are a first rotary polarization state apiece, while the second polarization state and the third polarization state are a second rotary polarization state apiece, wherein the first rotary polarization state is different from the second rotary polarization state.

11. The reflective display device of claim 10, wherein the first rotary polarization state is a left-handed polarization state, while the second rotary polarization state is a right-handed polarization state.

12. The reflective display device of claim 10, wherein the first rotary polarization state is a right-handed polarization state, while the second rotary polarization state is a left-handed polarization state.

13. The reflective display device of claim 5, wherein the external light further comprises:
a fifth color light, having a fifth polarization state;
a sixth color light, having a sixth polarization state, wherein a color of the fifth color light is the same as a color of the sixth color light, while the fifth color light and the sixth color light pass through the first display assembly and the second display assembly, wherein the reflective display device further comprises:
a third display assembly, disposed under the second display assembly, wherein the second display assembly is located between the first display assembly and the third display assembly, while the fifth color light and the sixth color light from the second display assembly enter the third display assembly, wherein the third display assembly comprises:
two third cholesteric liquid crystal modules, capable of reflecting the fifth color light; and
a third optical layer, disposed between the two third cholesteric liquid crystal modules, and converting the sixth color light passing through one of the two third cholesteric liquid crystal modules to the fifth color light having the fifth polarization state, so that the other one of the two third cholesteric liquid crystal modules reflects the fifth color light from the third optical layer.

14. The reflective display device of claim 13, further comprising a first light absorption layer, wherein the first light absorption layer is disposed between the first display assembly and the second display assembly,
wherein the first light absorption layer allows the third color light, the fourth color light, the fifth color light, and the sixth color light to pass, and is capable of absorbing a light outside multiple wavelength ranges of the third color light, the fourth color light, the fifth color light, and the sixth color light.

15. The reflective display device of claim 14, further comprising a second light absorption layer, wherein the second light absorption layer is disposed between the second display assembly and the third display assembly,
wherein the second light absorption layer allows the fifth color light and the sixth color light to pass, and is capable of absorbing a light outside the wavelength ranges of the fifth color light and the sixth color light.

16. The reflective display device of claim 14, wherein the first color light and the second color light are a blue light apiece;
the third color light and the fourth color light are a green light apiece;
the fifth color light and the sixth color light are a red light apiece.

17. A reflective display device, capable of reflecting an external light, wherein the external light comprises:
a first color light, having a first polarization state;
a second color light, having a second polarization state, wherein the first color light and the second color light are a blue light apiece;
a third color light, having a third polarization state;
a fourth color light, having a fourth polarization state, wherein the third color light and the fourth color light are a green light apiece;
a fifth color light, having a fifth polarization state;
a sixth color light, having a sixth polarization state, wherein the fifth color light and the sixth color light are a red light apiece,
wherein the reflective display device comprises:
a first display assembly, comprising:
two first cholesteric liquid crystal modules, capable of reflecting the first color light, wherein the third color light and the fourth color light pass through the first display assembly;
a first optical layer, disposed between the two first cholesteric liquid crystal modules, and capable of converting the second color light passing through one of the two first cholesteric liquid crystal modules to the first color light having the first polarization state, so that the other one of the two first cholesteric liquid crystal modules reflects the first color light from the first optical layer;
a second display assembly, disposed under the first display assembly and comprising:
two second cholesteric liquid crystal modules, capable of reflecting the third color light, wherein the third color light and the fourth color light both from the first display assembly enter the second display assembly, while the fifth color light and the sixth color light pass through the first display assembly and the second display assembly;
a second optical layer, disposed between the two second cholesteric liquid crystal modules, and capable of converting the fourth color light passing through one of the two second cholesteric liquid crystal modules to the third color light having the third polarization state, so that the other one of the two second cholesteric liquid crystal modules reflects the third color light from the second optical layer;
a third display assembly, disposed under the second display assembly, wherein the second display assembly is located between the first display assembly and the third display assembly, while the fifth color light and the sixth color light from the second display assembly enter the third display assembly, wherein the third display assembly comprises:
two third cholesteric liquid crystal modules, capable of reflecting the fifth color light; and
a third optical layer, disposed between the two third cholesteric liquid crystal modules, and converting the sixth color light passing through one of the two third cholesteric liquid crystal modules to the fifth color light having the fifth polarization state, so that the other one of the two third cholesteric liquid crystal modules reflects the fifth color light from the third optical layer.
